(19) United States
(12) Patent Application Publication
(10) Pub. No.: US 2026/0094217 A1
(43) Pub. Date: Apr. 2, 2026

(54) Machine Learning Systems and Methods for Automated Claims Data and Workflow Processing

(71) Applicant: Xactware Solutions, Inc., Lehi, UT (US)

(72) Inventors: Jeff Young, South Jordan, UT (US); Jeffery D. Lewis, Orem, UT (US); Aaron C. Brunko, Lindon, UT (US)

(73) Assignee: Xactware Solutions, Inc., Lehi, UT (US)

(21) Appl. No.: 19/346,945

(22) Filed: Oct. 1, 2025

Related U.S. Application Data
(60) Provisional application No. 63/702,047, filed on Oct. 1, 2024.

(51) Int. Cl. G06Q 40/08

(52) U.S. Cl. CPC G06Q 40/0841

(57) ABSTRACT

Machine learning systems and methods for automated claims data and workflow processing are provided. The system includes a property claims processing platform which monitors for one or more automation trigger events in connection with an insurance claims property file. When the one or more automation trigger events is detected, the system identifies and executes one or more automated claims processing workflows in response to the detected trigger events. The workflows can be pre-defined and/or user-defined workflows that are selected in response to pre-defined logic or heuristic rules, and/or they could be selected by one or more machine learning algorithms.

### RELATED APPLICATIONS

This application claims priority to U.S. Provisional Application Ser. No. 63/702,047 filed on Oct. 1, 2024, the entire disclosure of which is expressly incorporated herein by reference.

### TECHNICAL FIELD

The present disclosure relates generally to the field of machine learning. More specifically, the present disclosure relates to machine learning systems and methods for automated claims data and workflow processing.

### RELATED ART

In the insurance claims processing field, rapid and accurate processing of insurance claims is of paramount concern. Insurance claims processing software applications (e.g., executing on the web or on mobile devices) significantly improve the speed of processing such insurance claims, but users of such systems often must spend significant time manually entering data and/or performing various user interface tasks in order to process insurance claims, including mouse clicks, user interface (e.g., mobile device) “taps” on user interface elements, keystrokes, and other operations. This often slows processing of insurance claims and associated data by existing software platforms.

Machine learning (“ML”) and artificial intelligence (“AI”) are rapidly growing fields of computer science, and can be leveraged to simplify the operation of software platforms and their associated user interfaces. Such technology can also significantly improve the speed with which software platforms can process data, including, but not limited to, insurance claims data. As a result, ML and AI technologies are ripe for incorporation into insurance claims processing systems and associated platforms, but to date, there have not been adequate solutions developed for reliably automating data entry and workflow processing procedures for existing insurance claims software applications.

Accordingly, what would be desirable, but have not yet been provided, are machine learning systems and methods for automated claims data and workflow processing which address the foregoing and other needs.

### SUMMARY

The present disclosure relates to machine learning systems and methods for automated claims data and workflow processing. The system includes a property claims processing platform which monitors for one or more automation trigger events in connection with an insurance claims property file. When the one or more automation trigger events is detected, the system identifies and executes one or more automated claims processing workflows in response to the detected trigger events. The workflows can be pre-defined and/or user-defined workflows that are selected in response to pre-defined logic or heuristic rules, and/or they could be selected by one or more machine learning algorithms.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating overall components of the machine learning systems and methods of the present disclosure;

FIG. 2 is a flowchart illustrating processing steps carried out by the machine learning systems and methods of the present disclosure for automatically detecting trigger events associated with insurance claims data, and selecting and executing one or more processing workflows in response to the detected trigger events;

FIG. 3 is a flowchart illustrating processing steps carried out by the machine learning systems and methods of the present disclosure for automatically detecting weather events from insurance claims data and executing a workflow for processing insurance claims data in response to the detected weather events;

FIG. 4 is a flowchart illustrating processing steps carried out by the machine learning systems and methods of the present disclosure for automatically detecting fraudulent activities from insurance claims data and executing a workflow for processing insurance claims data in response to the detected fraudulent activities; and

FIG. 5 is a flowchart illustrating processing steps carried out by the machine learning systems and methods of the present disclosure for automatically triaging and processing insurance claims data.

### DETAILED DESCRIPTION

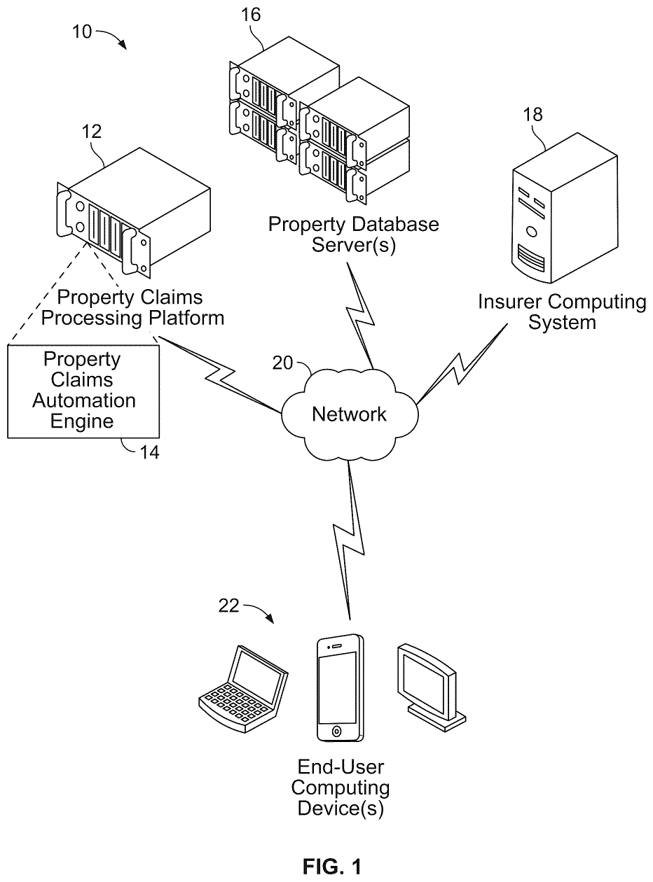

The present disclosure relates to machine learning systems and methods for automated claims data and workflow processing, as described in detail below in connection with FIGS. 1-5.

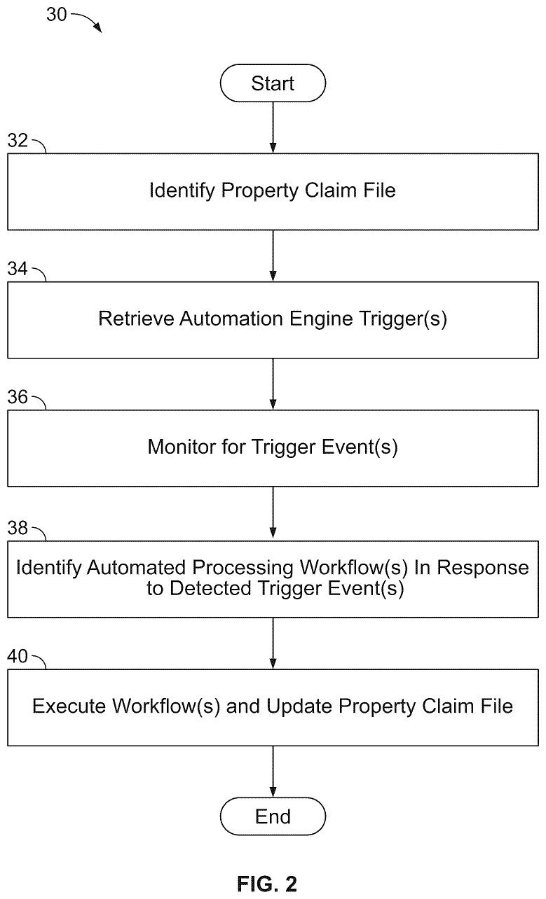

FIG. 1 is a diagram, indicated generally at 10, illustrating overall components of the machine learning systems and methods of the present disclosure. A property claims processing platform 12 is provided, and executed a property claims automation software engine 14 that is programmed in accordance with the processing steps described herein in connection with FIGS. 2-5. More specifically, the claims processing platform 12 automatically detects for one or more trigger events associated with insurance claims data using one or more heuristic, logic, or machine learning algorithms, and in response to detected trigger events, automatically identifies and executes one or more workflow processes in response to the detected trigger events. The processing platform 12 can obtain the insurance claims data from one or more property database servers 16, one or more insurer computing systems 18, and/or one or more end-user computing devices 22, each of which could be in communication with the claims processing platform 12 via a communications network 20.

The claims processing platform 12 could be any suitable computing platform capable of executing the software engine 14, including, but not limited to, a computer server, cloud processing platform, tablet computer, workstation, mobile device, and/or a smart telephone. Still further, the software engine 14 need not execute on the platform 12, but could instead execute on one or more of the servers 16, insurer computing system 18, and/or the end-user computing device(s) 22. The software engine 14 could comprise non-transitory, computer readable instructions stored on a memory associated with any of the devices shown in FIG. 1 and executed by such devices. Additionally, the software engine 14 could be programmed in any suitable high- or low-level computer programming language, including but not limited to, C, C++, C#, Java, Python, or any other suitable language.

FIG. 2 is a flowchart 30 illustrating processing steps carried out by the machine learning systems and methods of the present disclosure for automatically detecting trigger events associated with insurance claims data, and selecting and executing one or more processing workflows in response to the detected trigger events. In step 32, the system identifies one or more property claim data files. Such files could be obtained from the database server 16, the insurer computing system 18, one or more of the end-user computing devices 22, and/or from other sources.

Next, in step 34, the system retrieves one or more automation engine triggers. Such triggers can include, but are not limited to, creation of an insurance claim processing assignment, updating of such an assignment, rejection of an assignment, re-assignment of the assignment, addition of photos to an assignment (or claim estimate or project), addition of documents to the assignment (or estimate or project), addition of a policyholder photo to the assignment (or estimate or project), addition of a policyholder document to the assignment (or estimate or project), and/or addition of third-party data to the assignment (or estimate or project). In step 36, the system monitors for a trigger event defined by the one or more automation engine triggers. Importantly, the system can monitors for such triggers in real time.

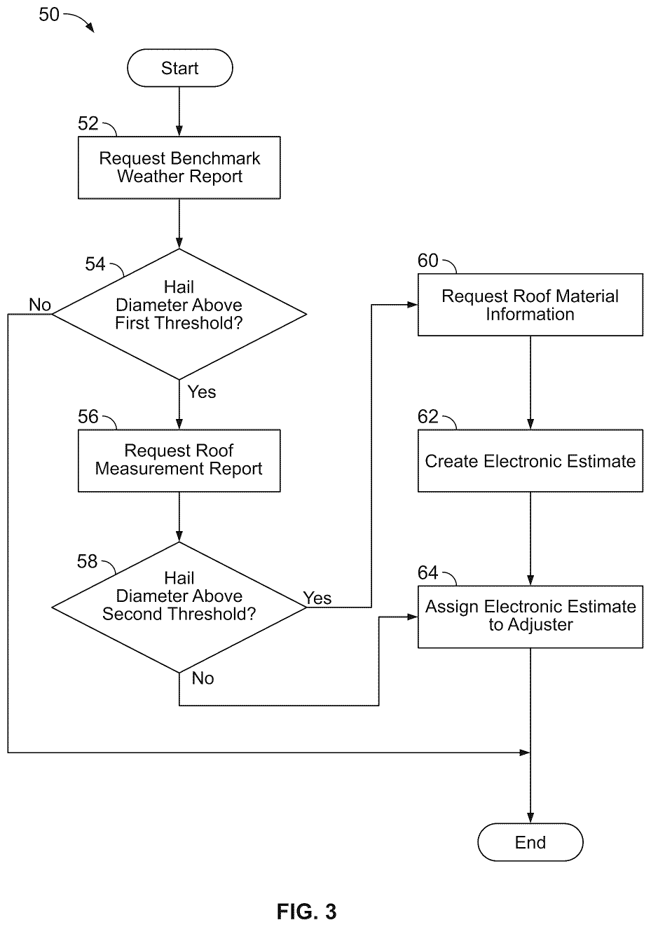

Next, in step 38, the system identifies one or more automated processing workflow(s) in response to the detected trigger event. A workflow is a series of steps (which could potentially be branching steps) which can be defined through a user interface or through text (e.g., in the form of a programming language). The system utilizes a combination of heuristic rules, generative AI, large language models, and historical data to allow for greater accuracy and specificity of automated workflows that allow for “straight-through” processing of insurance claims data, minimizing the requirement for user input/involvement. This significantly improves both the accuracy and speed of processing of insurance claims data by the system. Default workflow steps could be provided, and connections to application programming interfaces (APIs) could be incorporated in such workflows to allow for automatic retrieval of required data and processing of such data. End-users can also include (code) their own workflow steps, if desired. Such customer-generated workflow steps can be unique to the customer, and can allow customers to create, publish, and/or monetize workflow steps, if desired. Examples of such workflows are described in detail below in connection with FIGS. 3-5. Finally, in step 40, the system executes the workflow(s) and updates the property claim data file.

FIG. 3 is a flowchart 50 illustrating processing steps carried out by the machine learning systems and methods of the present disclosure for automatically detecting weather events from insurance claims data and executing a workflow for processing insurance claims data in response to the detected weather events. In step 52, whenever an insurance claims processing assignment is created (e.g., in an insurance claims processing software application/platform, such as the XACTNET and XACTANALYSIS by Xactware Solutions, Inc.), the system requests and obtains a benchmark weather report and processes the weather report to identify to hail data if the assignment type of loss is set to hail, wind, or a combination of hail and wind. In step 54, a determination is made as to whether the hail data indicates hail diameters above a first threshold (e.g., if the hail diameter is 1.8 inches or greater, but other values are possible). If not, processing ends. Otherwise, step 56 occurs, wherein the system requests a roof measurement report. Then, in step 58, a determination is made as to whether the hail diameter is above a second threshold (e.g., greater than 2.5 inches). If not, step 64 occurs, wherein the system generates and assigns an electronic estimate to an insurance adjuster for further processing. Otherwise, step 60 occurs, wherein the system requests roof material information (which could be provided by a third-party roof information source). Then, in step 62, the system automatically creates and populates an electronic estimate that includes both the roof measurement report and the roof material information, and in step 64, the system assigns the electronic estimate to an adjuster for further processing (e.g., for completion of the claim).

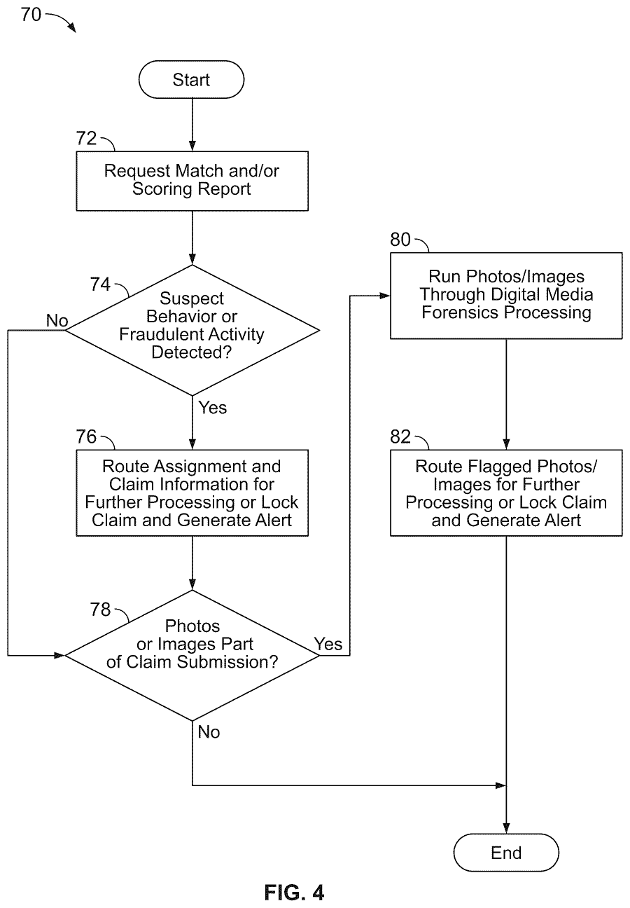

FIG. 4 is a flowchart 70 illustrating processing steps carried out by the machine learning systems and methods of the present disclosure for automatically detecting fraudulent activities from insurance claims data and executing a workflow for processing insurance claims data in response to the detected fraudulent activities. In step 72, whenever an insurance claims processing assignment is created (e.g., in an insurance claims processing software application/platform, such as the XACTNET and XACTANALYSIS by Xactware Solutions, Inc.), the system requests a match and/or scoring report. In step 74, the report is processed to detect suspect behavior or fraudulent activity (e.g., using the CLAIMSEARCH or CLAIMDIRECTOR fraud detection software applications/platforms by Insurance Services Office, Inc.). If no such activity is detected, step 78 occurs. Otherwise, step 76 occurs, wherein assignment and claim information is routed for further processing. Also, the insurance claim file could be locked by the system and/or an alert could be generated.

In step 78, a determination is made as to whether photos or images are part of a claim submission. If not, processing ends. Otherwise, step 80 occurs, wherein the system runs (processes) the photos and/or images through a digital media forensics processing system, which flags any of the photos and/or images that may be fraudulent. Finally, in step 82, the system routes the flagged photos and/or images for further processing. Additionally, the insurance claim file could be locked by the system and/or an alert could be generated.

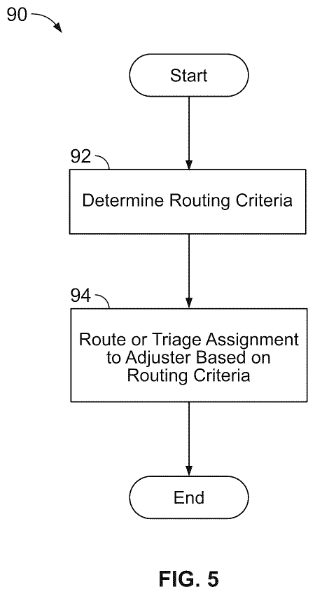

FIG. 5 is a flowchart 90 illustrating processing steps carried out by the machine learning systems and methods of the present disclosure for automatically triaging and processing insurance claims data. In step 92, the system identifies one or more routing criteria associated with insurance claims data. Such criteria can be determined through the application of rules and artificial intelligence, and could include, but is not limited to, the following: adjuster skill, qualifications, certifications, years of work history, workload, prediction of future claim load (including anticipated events), past adjuster estimate history, and/or geographic location. Then, in step 94, the system routes or triages an insurance claim assignment to an adjuster based on the routing criteria.

Having thus described the systems and methods in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A machine learning system for automated claims data and workflow processing, comprising:
a property claims processing platform in communication with a property database and at least one end-user computing device; and
a property claims automation engine executed by the property claims processing platform, the engine causing the platform to:
retrieve an insurance claims property file from the property database;
monitor for one or more automation trigger events associated with the insurance claims property file;
in response to detection of the one or more trigger events, identify and execute one or more automated claims processing workflows; and
update the insurance claims property file.

2. The system of claim 1, wherein the insurance claims property file is retrieved from an insurer computing system or the at least one end-user computing device.

3. The system of claim 1, wherein the one or more automation trigger events comprises one or more of creation of an insurance claim processing assignment, updating of the insurance claim processing assignment, rejection of the insurance claim processing assignment, re-assignment of the insurance claim processing assignment, addition of a photo to the insurance claim processing assignment, addition of a document to the insurance claim processing assignment, addition of a policyholder document to the insurance claim processing assignment, or addition of third-party data to the insurance claim processing assignment.

4. The system of claim 1, wherein the one or more automated claims processing workflows is defined through a user interface.

5. The system of claim 1, wherein the one or more automated claims processing workflows comprises one or more of a heuristic rule, a generative artificial intelligence (AI) model, a large language model, and historical data.

6. The system of claim 1, wherein the one or more automated claims processing workflows includes one or more application programming interface (API) calls for retrieving data required by the one or more automated claims processing workflows.

7. The system of claim 1, wherein the one or more automation triggers comprises a hail diameter being above a first threshold, and in response to the hail diameter being above the first threshold, the engine requests a roof measurement report.

8. The system of claim 7, wherein the one or more automation triggers comprises the hail diameter being above a second threshold, and in response to the hail diameter being above the second threshold, the engine requests roof material information and generates an electronic estimate that includes the roof measurement report and the roof material information.

9. The system of claim 1, wherein the one or more automation triggers comprises detection of fraudulent activity, and in response to detection of fraudulent activity, the system processes one or more photos or images of the insurance claims property file using a digital media forensics processing system that flags any of the one or more photos or images that are determined by the digital media forensics processing system to be fraudulent.

10. The system of claim 1, wherein the one or more automation triggers comprises identification of one or more routing criteria associated with insurance claims data, and in response to identification of the one or more routing criteria, the engine routes or triages an insurance claim adjustment to an adjuster based on the one or more routing criteria.

11. A machine learning method for automated claims data and workflow processing, comprising:
retrieving by a workflow processing platform an insurance claims property file from a property database;
monitoring for one or more automation trigger events associated with the insurance claims property file;
in response to detection of the one or more trigger events, identifying and executing one or more automated claims processing workflows; and
updating the insurance claims property file.

12. The method of claim 11, further comprising retrieving the insurance claims property file from an insurer computing system or at least one end-user computing device.

13. The method of claim 11, wherein the one or more automation trigger events comprises one or more of creation of an insurance claim processing assignment, updating of the insurance claim processing assignment, rejection of the insurance claim processing assignment, re-assignment of the insurance claim processing assignment, addition of a photo to the insurance claim processing assignment, addition of a document to the insurance claim processing assignment, addition of a policyholder document to the insurance claim processing assignment, or addition of third-party data to the insurance claim processing assignment.

14. The method of claim 11, wherein the one or more automated claims processing workflows is defined through a user interface.

15. The method of claim 11, wherein the one or more automated claims processing workflows comprises one or more of a heuristic rule, a generative artificial intelligence (AI) model, a large language model, and historical data.

16. The method of claim 11, wherein the one or more automated claims processing workflows includes one or more application programming interface (API) calls for retrieving data required by the one or more automated claims processing workflows.

17. The method of claim 11, wherein the one or more automation triggers comprises a hail diameter being above a first threshold, and in response to the hail diameter being above the first threshold, requesting a roof measurement report.

18. The method of claim 17, wherein the one or more automation triggers comprises the hail diameter being above a second threshold, and in response to the hail diameter being above the second threshold, requesting roof material information and generating an electronic estimate that includes the roof measurement report and the roof material information.

19. The method of claim 11, wherein the one or more automation triggers comprises detection of fraudulent activity, and in response to detection of fraudulent activity, processing one or more photos or images of the insurance claims property file using a digital media forensics processing system that flags any of the one or more photos or images that are determined by the digital media forensics processing system to be fraudulent.

20. The method of claim 11, wherein the one or more automation triggers comprises identification of one or more routing criteria associated with insurance claims data, and in response to identification of the one or more routing criteria, routing or triaging an insurance claim adjustment to an adjuster based on the one or more routing criteria.
